(19) United States
(12) Patent Application Publication
(10) Pub. No.: US 2023/0166328 A1
(43) Pub. Date: Jun. 1, 2023

(54) ADDITIVE MANUFACTURING COMPONENTS AND METHODS

(71) Applicant: Meta Additive Ltd., Stoke-On-Trent (GB)

(72) Inventors: Kate BLACK, Liverpool (GB); Paul CHALKER, Liverpool (GB); Christopher J SUTCLIFFE, Liverpool (GB)

(21) Appl. No.: 17/921,643

(22) PCT Filed: Apr. 28, 2021
(86) PCT No.: PCT/GB2021/051024

§ 371 Date: Oct. 27, 2022

(30) Foreign Application Priority Data
May 1, 2020 (GB) 2006475.4

(51) Int. Cl. B22F 10/14; B22F 10/50; B22F 10/64; B33Y 80/00; B33Y 10/00

(52) U.S. Cl. CPC B22F 10/14; B22F 10/50; B22F 10/64; B33Y 80/00; B33Y 10/00; B22F 2302/10; B22F 2302/05; B22F 2302/20; B22F 2301/205; B22F 2301/052; B33Y 30/00

(57) ABSTRACT

A method of 3D printing a metal or alloy product includes providing a layer of a powder bed which comprises a compound of a first metal, and optionally also said first metal in elemental form and/or optionally other elemental metal(s) which are suitable for alloying with said first metal; jetting a functional binder onto selected parts of said layer, wherein said functional binder infiltrates into pores in the powder bed, reacts with said compound of a first metal to form said first metal in elemental form, and locally fuses elemental metal particles of the powder bed in situ, sequentially repeating said steps of applying a layer of powder on top and selectively jetting functional binder, multiple times, to provide a powder bed bonded at selected locations by printed functional binder and; taking the resultant bound 3D structure out of the powder bed.

### CROSS-REFERENCE TO RELATED APPLICATIONS

This application is a U.S. National Stage Application of International Application No. PCT/GB2021/051024, filed on Apr. 28, 2021, and claims priority under 35 U.S.C. § 119(a) and 35 U.S.C. § 365(b) from GB Patent Application No. 2006475.4, filed on May 1, 2020; the disclosures of which are incorporated herein by reference.

### FIELD

Various embodiments of the present disclosure relate to additive manufacturing, also known as 3D printing, and in particular to binder jetting, components used in binder jetting, and resultant products which contain metals or alloys.

### BACKGROUND

Additive manufacturing, commonly referred to as 3D printing, is a term which encompasses several categories of processes by which 3D objects are formed or “printed”. The 3D objects are generally built up layer by layer, and the processes differ in the way that the layers are formed and in what they are made from.

Some processes entail polymerizing or curing liquid material. For example, in vat photopolymerization, a platform is lowered into a vat of liquid polymerizable material (e.g. epoxy acrylate resin) so that it is slightly below the surface. Laser radiation is used to polymerize and harden selective parts of the layer above the platform. The platform is then lowered slightly so that a new liquid layer is at the surface (this may be made uniform by using a levelling or coating blade) and the polymerization process is repeated. This procedure of lowering, coating and polymerizing is repeated layer by layer until the desired three-dimensional structure has been formed. The platform may then be raised and the product removed and processed further. Post-processing typically involves the removal of support structures (which may be formed during the polymerization steps) and any other residual material, and then high temperature curing following by finishing, e.g. sanding of the product. Some other processes entail forming each layer of a 3D structure by extruding a plastic or polymer material (or, less commonly, other material). This is known as extrusion deposition or fused deposition modelling (FDM). Material, e.g. a polylactic acid resin, is fed to an extruder where it is heated and extruded through a nozzle which moves in X and Y directions. The selectively deposited material solidifies on cooling. As with vat polymerization methods, the structure usually rests on a build platform which typically moves downwards between the deposition of each layer, and support structures are typically required, particularly for overhanging parts of structures. Such extrusion methods are amongst the most common 3D printing processes and used widely in consumer 3D printers. Another category of additive manufacturing is material jetting which is similar to extrusion deposition in that material is deposited via a nozzle which moves in X and Y directions. Instead of being extruded, the material is jetted onto a platform. The material (e.g. wax or polymer) is applied as droplets using a print head, similar to conventional two-dimensional inkjet printing. The droplets solidify and then successive layers are applied. Once the structure is formed it may be subjected to curing and post-processing. As with other methods discussed above, support structures may be incorporated during the procedure and then removed during post processing.

Powder bed fusion (PBF) methods entail the selective binding of granular materials. This can be done by melting and fusing together part of the powder or particles of a layer of material, then lowering the bed, adding a further layer of powder and repeating the melting and fusing process. The unfused powder around the fused material provides support so unlike some methods discussed above it may not be necessary to use support structures. Such methods include direct metal laser sintering (DMLS), electron beam melting (EBM), selective heat sintering (SHS), selective laser melting (SLM) and selective laser sintering (SLS). In view of the types of materials which are compatible with such processes (including metals and polymers), functional high strength materials can be manufactured.

Binder jetting methods are similar to powder bed fusion methods in that they use layers of powder or particulate material. However, conventional binder jetting methods differ from powder bed fusion methods in that the powder is not initially fused together but instead is held together with a binder which is jetted onto the structure from a print head. The binder may be colored and the color may be imparted to the powder thereby allowing color 3D printing. Typically a binder is applied in a specific pattern to a layer of powder, and then the steps of applying a layer of powder and selectively applying binder are repeated.

In general, binder jetting entails the use of binder as a sacrificial material which is altered or removed in a post-processing step. This is because the adhesive binder typically imparts enough mechanical strength (termed “green strength”) to enable the structure to be self-supporting and maintain its shape as it is built up, and to withstand mechanical operations during manufacture, but not enough strength to be functional for the intended end use. Thus the structure is usually subsequently heated to remove the binder (de-binding process) and to fuse the build material together in a post-processing step to ensure that the product is fit for purpose which may include load-bearing or other applications.

Binder jetting is also referred to as the “drop-on” technique, “powder bed and inkjet 3D printing”, or sometimes just “3D printing”, though as summarized here there are many other different types of 3D printing. The binder used in binder jetting is generally liquid and is often referred to as “ink” in view of the inkjet application process.

One challenge with traditional binder jetting relates to porosity. The post processing heat treatment step removes the binder and fuses the structure, but leaves significant porosity. This is partly due to the inherent packing densities which are possible with the particles of the powder bed, and partly due to the de binding process. The de-binding process can also cause further problems, in particular shrinkage and contamination. The pores which remain can compromise mechanical properties. A further step of infiltration can be used to fill the pores, but this adds complexity and generally requires a different type of material so that the end product is generally weaker than an equivalent material made from a single material and is more difficult to recycle.

Yet further methods of 3D printing include lamination methods (wherein single sheets are formed and laminated together), and directed energy deposition (where powder is supplied to a surface and melted on deposition by e.g. a laser beam).

An Innovate UK assessment estimated the worldwide market for all additive manufacturing products and services to be worth $4.1 billion in 2014. Currently the sector has experienced a compound annual global growth rate of 35% over the last three years, driven by direct part production, which now represents 43% of the total revenue (“Shaping our National Competency in Additive Manufacturing”, 2012: https://connect.innovateuk.org). Future growth is forecast to be about $21 billion by 2020, which is expected to be driven by the adoption of additive manufacturing by the aerospace, medical devices, automotive and creative industries (“3D Printing and Additive Manufacturing State of the Industry,” W.A. Fort Collins, Editor 2014). Additive manufacturing has become a core technology within the field of high value manufacturing. Metals are the fastest-growing segment of the additive manufacturing sector, with printer sales growing at 48% and material sales increasing by 32% (Harrop, R. G. A. J., 3D Printing of Metals 2015-2025 Pricing, properties and projections for 3D printing equipment, materials and applications, IDTechEX, 2015.) Campbell et al (Campbell L, R. I., Bourell, D. and Gibson, I., “Additive manufacturing: rapid prototyping comes of age,” Rapid Prototyping Journal, 2012, 18(4): p. 255) have noted that the industry drivers for the development of additive manufacturing technology can be differentiated as:
Automotive—the ability to deliver new products to market quickly and predictably, significantly reduces overall vehicle development costs.
Aerospace—realization of highly complex and high performance parts with integrated mechanical function, elimination of assembly features and enabling the creation of internal functionality (e.g. cooling etc.)
Medical—translation of 3D medical imaging data into customized solid medical devices, implants and prostheses.

Additive manufacturing is regarded as a disruptive technology that could be revolutionary and game changing, if barriers such as inconsistent material properties can be overcome. The present invention directly addresses this issue.

Some additive manufacturing methods use reactive metal jet fusion (RMJF) printing. This addresses some of the problems outlined above by jetting a material which not only binds selected parts of a powder bed layer together, but also becomes part of the build material: the binder is functional rather than sacrificial. The powder bed particles are fused in situ by application of the binder.

### BRIEF DESCRIPTION OF THE DRAWINGS

In the following description, characteristics and advantages of the present disclosure will become more apparent from the following detailed description of the various embodiments with reference to the attached drawings, in which:

FIG. 1 shows products formed on reaction of titanium hydride powders with a binder comprising tetrakis(dimethylamido)titanium;

FIG. 2a shows a scanning electron microscope (SEM) image of reaction product of elemental titanium powder (in the absence of titanium hydride) with tetrakis(dimethylamido)titanium;

FIG. 2b shows an SEM image of a reaction product of a powder mixture of elemental titanium and titanium hydride with tetrakis(dimethylamido)titanium; and

FIG. 3 is a graph showing an increase in titanium content brought about when producing build material from two different powder blends of CP-TkTiFb

### DETAILED DESCRIPTION

Various embodiments of present disclosure relate to reactive metal jet fusion (RMJF) printing, and in particular to methods in the preparation of metal or metal-containing products or parts.

A first aspect the present disclosure includes a method of 3D printing a metal or alloy product comprising:
(i) providing a layer of a powder bed which comprises a compound of a first metal, and optionally also said first metal in elemental form and/or optionally other elemental metal(s) which are suitable for alloying with said first metal; (ii) jetting a functional binder onto selected parts of said layer, wherein said functional binder infiltrates into pores in the powder bed, reacts with said compound of a first metal to form said first metal in elemental form, and locally fuses elemental metal particles of the powder bed in situ,
(iii) sequentially repeating said steps of applying a layer of powder on top and selectively jetting functional binder, multiple times, to provide a powder bed bonded at selected locations by printed functional binder; and
(iv) taking the resultant bound 3D structure out of the powder bed.

“Functional binder” herein means a binder which not only binds together the build material (conventionally the build material comprises the powder bed particles) but also becomes part of the build material. Aspects of the present disclosure allow the production of end products which are functional products rather than prototypes. The functional binder is non-sacrificial: it contributes to the functional properties of the end product, e.g. properties of strength, low density, stability, inertness or corrosion resistance, so that the end product may be suitable for use as a product, part or component in for example aerospace, military, marine, medical or industrial applications. Such products, parts or components may for example be components of aircraft, vehicles, marine structures or devices adapted to be used in or on the body.

The binder reacts with the compound of a first metal in the powder bed to form elemental metal. The binder also interacts with the surfaces of the elemental metal powder bed particles where present so as to bind them together. The binder may do this directly or indirectly; in the latter case the binder may react during the jetting and/or deposition process to produce a more reactive species which then reacts with, and binds to, the surfaces of the powder bed particles.

The binder is suitably a metallic binder which binds together the powder bed particles with elemental metal.

The binder is jetted onto the powder bed, and analogously to the ink-jetting of ink onto paper in ink-jet printing, the binder may be referred to as “ink”.

The powder bed contains at least a compound of a first metal which reacts with the functional binder in the ink. Thus, in aspects of the present disclosure, there is a reactive component in not only the ink but also in the powder bed. This facilitates processes in which the 3D printed part can be prepared more efficiently and/or with a lower thermal budget; in some circumstances heat is not required to activate the reaction.

Said compound of a first metal is suitably in solid form in the powder bed, rather than being in solution or suspension. It may be a particulate material or a coating on a particulate material, for example a coating on particles of elemental metal(s). It may be reactive under ambient conditions or may be reactive when heat-treated. Said compound of a first metal in the powder bed may react with the functional metallic binder in the ink so that both are converted to elemental metal which becomes part of the build material.

Said compound of a first metal may be a reducing agent. The reducing agent is typically reducing for metals. One advantage of this is that this may help prevent the oxidation or gettering of metals during the process, thereby avoiding or reducing the presence of oxide impurities which may be detrimental to the strength and other properties of the product. This can be particularly beneficial with metals which are susceptible to gettering during 3D printing processes, for example titanium.

This can contrast with known methods which use an inert atmosphere, e.g. argon or nitrogen gas, to avoid undesirable reactions. In aspects of the present disclosure the reactive, reducing, component is in a solid form, as opposed to being a reducing gas.

Another advantage of this is that this may facilitate the reaction with functional binder in the ink. For example, said compound of a first metal in the powder bed may react with, or reduce, a reactive organometallic material in the ink, thereby converting said reactive organometallic material to elemental metal and removing ligands or non-metallic components or salts.

The presence of a reactive material in the powder bed furthermore means that the process may in some circumstances be carried out at a lower temperature than that which would be required in its absence.

The compound of a first metal, i.e. the reactive material in the powder bed, may be, for example, a compound of titanium, or a compound of aluminum, or a compound of vanadium, or a compound of niobium. A mixture of one or more of such compounds may be used. The compound(s) may be, for example, selected from hydride, carbide, nitride, or boride compounds.

One suitable category of products which may be prepared in accordance with exemplary embodiments of the present disclosure includes titanium products and titanium alloy products. The control allowed by exemplary embodiments of the present disclosure means that it is particularly effective and advantageous in the preparation of titanium-containing products.

For example, the compound of a first metal, or at least one of them, may be a metal hydride. To produce pure titanium products, the compound of a first metal used in the powder bed is a titanium compound, for example titanium hydride, and the functional binder in the ink is a titanium-containing binder. To produce titanium alloy products, one possibility is that the compound in the powder bed may be a titanium compound, for example titanium hydride, and the other metal(s) in the alloy may be derived from other (elemental) metal particles in the powder bed or derived from material in the binder, as well as further titanium being optionally present in the powder bed and/or binder. An alternative possibility for titanium alloy products is that the compound in the powder bed may be a compound of a metal which alloys with titanium, for example a hydride of said metal (other than titanium), and the titanium in the alloy may be derived from titanium metal particles in the powder bed and/or derived from material in the binder.

Thus, to make pure titanium products, it is necessary to use a titanium-containing functional binder, and a powder bed containing a titanium compound, for example titanium hydride. Optionally, elemental titanium may also be present in the powder bed. Optionally elemental titanium may also be present in the binder.

To make titanium alloy products, it is necessary to incorporate one or more other metal which alloys with titanium, and this can be done by including said other metal(s) in the powder bed or in the binder or both. Said other metal may be in elemental form in the powder bed and/or binder, and/or may be in the reactive compound of the powder bed and/or the functional binder. To prepare such titanium alloys, titanium may be in elemental form in the powder bed and/or binder, and/or may be in the reactive compound of the powder bed and/or the functional binder. One exemplary method within the scope of the present disclosure uses titanium hydride as an essential component in the powder bed. This is a method of 3D printing a titanium or titanium alloy product comprising: (i) providing a layer of a powder bed which comprises titanium hydride particles and optionally particles of elemental titanium and/or optionally other elemental metal(s) which are suitable for alloying with titanium;
(ii) jetting a functional binder onto selected parts of said layer, wherein said functional binder infiltrates into pores in the powder bed, reacts with titanium hydride particles to form elemental titanium, and locally fuses elemental metal particles of the powder bed in situ,
(iii) sequentially repeating said steps of applying a layer of powder on top and selectively jetting functional binder, multiple times, to provide a powder bed bonded at selected locations by printed functional binder; and (iv) taking the resultant bound 3D structure out of the powder bed.

For example: a suitable method of making a pure titanium product in accordance with exemplary embodiments of the present disclosure is to use a titanium-containing binder in combination with a powder bed which consists of titanium hydride; another suitable method of making a pure titanium product in accordance with exemplary embodiments of the present disclosure is to use a titanium-containing binder in combination with a powder bed which consists of titanium hydride and elemental titanium; a suitable method of making a titanium alloy product in accordance with exemplary embodiments the present disclosure is to use a titanium-containing binder in combination with a powder bed which consists of titanium hydride and elemental other metal(s); another suitable method of making a titanium alloy product in accordance with exemplary embodiments of the present disclosure is to use a titanium-containing binder in combination with a powder bed which consists of titanium hydride, optionally elemental titanium and elemental other metal(s); another suitable method of making a titanium alloy product in accordance with exemplary embodiments of the present disclosure is to use a binder which contains a metal which alloys with titanium (regardless of whether said binder also contains titanium) in combination with a powder bed which consists of titanium hydride, optionally elemental titanium and optionally elemental other metal(s).

Thus, when making an alloy, one option is to include the alloying material in the powder bed; another option is to include the alloying material in the ink; a further option is to have alloying material in both the ink and the powder bed.

The other metal(s) include one or more of those which are known to alloy with titanium, such as aluminum, vanadium, niobium, tantalum, zirconium, iron, chromium, cobalt, nickel and/or copper.

One group of suitable resultant alloys is that wherein the alloys contain titanium, aluminum and vanadium. One example within this group is Ti-6Al-4V. This is an alloy which contains approximately 6 wt. % (e.g. 5.5-6.75 wt. %) Al and 4 wt. % (e.g. 3.5-4.5 wt. %) V, the balance being titanium and unavoidable impurities. Oxygen and other elements may be present in small amounts. This alloy is particularly useful in implants and prostheses, in the aerospace industry, for marine applications and in chemical engineering applications.

Another group of suitable resultant alloys is that wherein the alloys contain titanium, aluminum and niobium. One example within this group is Ti-6Al-7Nb. This is an alloy which contains approximately 6 wt. % (e.g. 5.5-6.5 wt. %) Al and 7 wt. % (e.g. 6.5-7.5 wt. %) Nb, the balance being titanium and unavoidable impurities. Oxygen and other elements may be present in small amounts. Titanium-aluminum-niobium alloys are similar to titanium-aluminum-vanadium alloys in their properties and applications and in some contexts the presence of niobium rather than vanadium is preferred, for example due to increased biotolerance.

Another group of suitable resultant alloys is that wherein the alloys contain titanium, aluminum and zirconium, and in some cases molybdenum and/or vanadium. One example within this group is TA15 (Ti-6.5Al-2Zr-1Mo-1V). This is an alloy which contains approximately 6.5 wt. % (e.g. 5.5-7.1 wt. %) Al, 2 wt. % (e.g. 1.5-2.5 wt. %) Zr, 1 wt. % (e.g. 0.5-2.0 wt. %) Mb and 1 wt. % (e.g. 0.8 to 2.5 wt. %) V, the balance being titanium and unavoidable impurities. Oxygen and other elements may be present in small amounts. Another group of suitable resultant alloys is that wherein the alloys contain titanium and niobium, and in some cases zirconium and/or tin. One example within this group is Ti-24Nb-4Zr-8Sn. This is an alloy which contains approximately 24 wt. % Nb, 4 wt. % Zr and 8 wt. % Sn, the balance being titanium and unavoidable impurities. Oxygen and other elements may be present in small amounts.

In such scenarios, at least one exemplary embodiment of the present disclosure includes having, as an essential, reactive, component, titanium hydride (Tihh) in the powder bed. This reacts to form titanium during the process. The presence of this reactive component (titanium hydride) in the powder bed, in the context of an exemplary method of the present disclosure, can bring particular advantageous effects.

An advantage of using titanium hydride in the powder bed is that this better controls reactivity during the formation of the titanium build material, compared to powder beds which contain elemental titanium. When elemental titanium alone is used in the powder bed, undesirable oxidation can occur more readily, and/or other side reactions may occur more readily. This can lead to an inferior product or lower purity. Without wishing to be bound by theory, this undesirable effect is thought to be due to reaction of the elemental titanium powder bed particles when the functional binder is used to bind the powder bed particles together. The presence of titanium hydride reduces the amount of oxidation or other undesirable reaction taking place.

A further advantage of using a compound of a first metal, for example titanium hydride, in the powder bed is that this allows the packing density to be controlled and enhanced. Conventionally, binder jetting takes place onto powder beds which contain approximately spherical particles of elemental material, and a maximum bed density of around 60% is achieved. The compound of the first metal, for example titanium hydride, can be in the form of particles which can have a range of shapes and dimensions including irregular and dendritic forms which can pack well. Thus a beneficial density modification effect is observed. This beneficial density modification effect is particularly pronounced when the powder bed contains not only the compound of the first metal, for example titanium hydride, but also particles of other material. The presence of two or more types of material, typically titanium hydride particles and elemental titanium particles and/or particles of other metal, in the powder bed, facilitates a bimodal or multimodal size distribution which leads to improved part density.

Titanium hydride is a readily available and relatively inexpensive material and accordingly the use of titanium hydride is a cost-effective way of controlling reactivity in reactive metal jet fusion printing using titanium functional binders. The ready availability and low cost of titanium hydride stems from it being produced in large quantities during other industrial processes.

Various embodiments of the present disclosure achieve packing densities and oxygen contents that could otherwise only be obtained by careful control of purity and size and shape of particles, which would be costly. Conventional gas atomized metallic particles which are commonly used in binder jet printing are significantly more costly to produce.

In exemplary embodiments of the present disclosure, the functional metallic binder infiltrates into the voids between the powder-bed particles in situ, and the powder-bed particles are fused in situ by application of the binder. The latter is due to the reaction with the functional binder and may also be facilitated by carrying out the process on a powder bed at a higher temperature than is conventional (conventionally, in binder jetting methods, powder beds are not heated). Without wishing to be bound by theory, chemical and physical processes are involved in forming the build material. The binder formulation may undergo a chemical transformation to for example result in a metal which physically fuses with the surrounding powder bed. The physical process may involve adsorption, diffusion and/or melting depending on the powder bed temperature.

The functional binder contrasts with organic adhesive binders which have commonly been used hitherto. Various embodiments of the present disclosure allow the ink to be used as a means of incorporating metal into the structure. The metal remains in the end product even if a post-processing step of higher temperature sintering is carried out. This can contrasts with, and brings advantages with respect to, the conventional or known use of sacrificial binders.

It should also be noted that exemplary embodiments of the present disclosure relate to the preparation of functional components or parts rather than mere prototypes. Binder jetting has previously been used in rapid prototyping: it enables 3D models to be produced easily. Such 3D models are not functional—their purpose generally relates to their appearance.

The infiltration of the binder into the voids between the powder-bed particles in situ differs from the conventional application of a binder which merely adhesively secures the powder bed layers. In the latter, significant porosity remains and this can lead to shrinkage or may require an infiltration procedure to be carried out in a post-processing step. In exemplary embodiments of the present disclosure, the in situ infiltration results in a simpler process and enables reliable manufacturing of structures whilst addressing shrinkage issues.

Optionally, the extent of infiltration may be such that the residual porosity by volume of the product prepared by the method of the first aspect, before post-processing, may be no greater than 30%, or no greater than 20%, or no greater than 10%, or no greater than 5%, or no greater than 1%. In comparison, the achievable density in a conventional powder bed is of the order of 60% due to constraints on packing densities, so that conventional residual porosities are of the order of 40%. An extensive level of infiltration may be achieved by the metal binder conformally coating the particles of the powder bed at a surface level. The binders fill, or partially fill, the interstices between the powder bed particles. The binders may contain molecular components which enable surface-driven reactions to bring about chemical fusing, in contrast to the binding provided by conventional binder jet printing. Additionally the presence of the reactive compound of the first metal in the powder bed (e.g. titanium hydride) increases the possibility for improved packing because said compound can be of different sizes and shapes and can help fill voids between larger particles, e.g. of elemental material.

The porosity may be measured by computed tomography (CT), e.g. according to the method described in Mattana et al, Iberoamerican Journal of Applied Computing, 2014, V. 4, N. 1, pp 18-28 (ISSN 2237-4523). The in situ fusing (e.g. joining, aggregation or bonding) of the powder particles with the metal of the binder brings further advantages compared to the use of a sacrificial adhesive binder; in particular the green strength of the material is enhanced, and composite and a wider range of tailored structures can be prepared.

Optionally one or more further step of post-processing may be carried out. In particular, the product may be heat-treated to consolidate and further strengthen, e.g. fuse, the structure. This may be done either after the application of each layer or after the entire structure has been built. The heat treatment step may be carried out at a temperature suitable for the material being used. For example, in some cases, it is beneficial to carry out a heat treatment step at a temperature towards, but not exceeding, the melting point of the material. It should be noted that this is a heat treatment step in contrast to the chemical process which occurs on application of the binder to the powder bed particles. The inclusion of reactive components in the powder bed can facilitate lower processing temperatures and/or shorter processing times than would otherwise be required in conventional binder jet printing. Thus the present method facilitates the preparation of dense, optionally substantially fully dense, functional, 3D printed parts and in particular is a step forward with regard to metal additive manufacturing.

Hitherto, only the powder bed fusion (PBF) technologies, such as selective laser melting (SLM), and more recently electron beam melting (EBM), have made significant inroads into the functional metal part market. These fusion based technologies, although impressive, have a number of problems, some related to the sub-optimal microstructure and others to scalability. The scalability has led to a limit on the size of objects that can be produced, lengthy manufacturing times, relatively high costs, problems with residual stress, and increasing difficulties with production as the size of the part increases. These problems have restricted SLM and EBM technologies to smaller, high added value-parts, and it is difficult to see how the technology can be scaled while controlling or reducing costs. Various embodiments of the present disclosure can in effect combine the flexibility and agility of the laser powder melting techniques with the low cost of older powder bed print technologies, and further addresses issues specific to the preparation of titanium and titanium alloy products.

Various embodiments of the present disclosure can benefit from some advantages of the binder jetting process compared to the powder bed fusion processes such as SLM and EBM (including: no support structures being required during the forming process, much higher layup speeds, ease of scaling and lack of internal stresses). At the same time exemplary embodiments of the present disclosure can address an Achilles' heel of known binder jet technology in that it infiltrates the pores with metal binder which makes the products suitable for use as functional components, and avoids using weak binders which can lead to the parts sagging during post processing.

The binder of the exemplary embodiments of the present disclosure is a metal-containing material which may be applied by a jetting process to result in a metal, alloy or compound bound to the surfaces of the powder particles in the powder bed. The binder may be in the form of a compound, salt or reagent, and may be in a carrier medium (e.g. a solvent), and the formulation may also comprise other components e.g. co-reagents (which may for example facilitate the conversion of compounds to elemental metals), other particles, and rheological agents to facilitate jetting, amongst other components.

The binder may comprise a molecular precursor of a metal or alloy, for example an organometallic material. The organometallic material may be a compound or complex which can react in situ to result in a metal or alloy bound to the surface. The material may be referred to as a reactive organometallic ink because it is printed onto the powder bed and reacts with the particulate material in the exposed powder bed layer.

Thus, the functional binder in exemplary embodiments of the present disclosure can be a metallic functional binder “ink” which may contain reactive metal compound(s), and amongst the most useful of reactive metal compounds are organometallics. Reactive organometallic (ROM) material undergoes reaction to lose ligands and change to elemental metal and bind to the particles of the powder bed.

An organometallic material used in the functional binder may be a titanium precursor, i.e. a titanium compound which reacts to form elemental titanium. For example, the organometallic material may comprise titanium (e.g. titanium IV) carrying ligands. The ligands may for example be NR1R2 where Ri and R2 are alkyl groups e.g. where both Ri and R2 are CH3. Optionally one or more of the NR1R2 ligands may be replaced by a different ligand, for example an optionally substituted alkyl group (e.g. Ci-C5 alkyl), an optionally substituted aryl group (e.g. phenyl), an optionally substituted heteroaryl group, or an S- P- or Si-containing ligand.

Thus the functional binder may comprise Ti(NRiR2)4-x(Y)x wherein: Ri and R2 are alkyl groups e.g. where both Ri and R2 are CH3; wherein Y is an optionally substituted alkyl group (e.g. Ci-C5 alkyl), an optionally substituted aryl group (e.g. phenyl), an optionally substituted heteroaryl group, or an S- P- or Si-containing ligand; and wherein x is 0, 1, 2 or 3.

The functional binder may comprise Ti[N(CH3)2]4 which is known as tetrakis(dimethylamino)titanium(IV), tetrakis(dimethylamido)titanium(IV) or TDMA-Ti.

The aforementioned advantages of using titanium hydride in the powder bed are particularly pronounced when an organometallic titanium material is used as or in the functional binder. The combination of the reactive component in the ink (organometallic titanium compound) and the reactive component in the powder bed (titanium hydride) results in reduction of the organometallic titanium compound to elemental titanium by the titanium hydride, and decreases the extent of, or avoids, undesirable oxidation or other undesirable reactions.

The present inventors have recognized that sufficient titanium hydride should be used (relative to functional binder) in order to facilitate the reduction of the titanium precursor to titanium whilst controlling reactivity, and that the amount of titanium hydride should not be excessive because otherwise unreacted titanium hydride is left in the product. The skilled person can, without undue burden, alter the relative amounts and other conditions, to obtain an effective and pure product.

The inventors have also found that when a titanium precursor is used in the functional binder and the powder bed comprises solely elemental titanium (i.e. in the absence of titanium hydride), the binding of the powder particles is not as effective and the resultant part is not as strong. The titanium precursor and other materials used in the functional binder are typically dissolved or suspended in a solvent, for example toluene.

Various embodiments of the present disclosure can be advantageous in providing new methodologies which allow a product to be tailored by: modifying the fractions of reactive compound and elemental material (e.g. titanium hydride, titanium and other materials) in the powder bed; choosing from a selection of grain types and sizes of particles in respect of each of the materials in the powder bed; selecting appropriate functional binder components including choosing titanium organometallic materials and/or other materials; choosing appropriate particle size distributions in respect of elemental materials in the functional binder; formulating appropriate binder compositions using a solvent; and selecting certain reaction and treatment temperatures and other conditions.

Optionally the amount of reactive compound(s) in the powder bed may be within the range of 1-100% by weight, or 1-99% by weight, or 5-95% by weight, or 20 to 90% by weight, or 40 to 80% by weight, or 50 to 75% by weight. Optionally the balance may be elemental metal(s).

Optionally the binder composition may comprise, in addition to a component which reacts at the molecular level (e.g. ROM), nanoparticles e.g. metal nanoparticles. Optionally it may further comprise microparticles, e.g. metal microparticles.

The metallic binders (or inks) are capable of chemically fusing metal powders through a chemical transformation or conversion. During this process a metal adlayer joins the powder bed particles. This is analogous to joining parts using a molten solder.

Optionally the metal used in exemplary embodiments of the present disclosure may have a size-distribution ranging from the molecular to nanoparticle through to the microparticle size or any mixture thereof. The purpose of having a range of different particle sizes is to achieve extensively or fully densified microstructures. Thus, while reactive materials e.g. organometallic (ROM) materials result in conformal coating of the powder bed particles at the surface level, nano- and/or micro-particles fill the bulk of the voids or interstices. Therefore, optionally, the functional binder may comprise at least two components: a reactive material and a nanoparticulate and/or microparticulate material. Optionally the binder may comprise at least three components: a reactive material; a nanoparticulate material and a microparticulate material.

Thus the skilled person will understand that a spectrum of particle sizes should be used in the binder (which may for example range from molecular materials to nanoparticulate materials to microparticulate materials), to enable the space and interstices between the powder bed particles to be effectively filled.

The most effective distribution of particle sizes to be used is preordained by the nature of the components making up the powder bed. The present inventors have recognized that, for any particular desired final material, a suitable matrix for the powder bed can be chosen, and that this then predetermines the distribution of particle sizes of the “ink” which will be appropriate to produce a fully-filled, fully-functional material.

By nanoparticulate is meant that the particle size is on average within the ranges 1 to 100 nm, or 5 to 100 nm, or 1 to 50 nm, or 1 to 20 nm, or 1 to 10 nm, or 2 to 8 nm, or 3 to 7 nm, or about 5 nm).

By microparticulate is meant that the particle size in the ink is on average within the ranges 0.1 to 10 microns, or 0.1 to 5 microns, or 1 to 5 microns, or 1 to 3 microns.

Thus it may be that the binder composition may comprise three components which, along with the powder bed particles, form the build material: a functional binder fraction, a nanoparticulate fraction and a microparticulate fraction. It may be that the functional binder fraction forms 0.1-10%, e.g. 0.5-8%, e.g. 0.7-2%, e.g. 0.8-1.2%, e.g about 1%, of the volume of the product. It may be that the nanoparticulate fraction and the microparticulate fraction together form 10-50%, e.g. 20-45%, e.g. 30-40%, e.g. 35-40% of the volume of the product. It may be that the ratio of nanoparticulate to microparticulate fraction in the product, by volume, is between 10:1 and 1:10, e.g. between 5:1 and 1:5, e.g. between 2:1 and 1:2, e.g. between 10:1 and 1:1, e.g. between 5:1 and 2:1, e.g. between 1:1 and 10:1, e.g. between 2:1 and 5:1.

The skillset of those working in 3D printing has generally not included detailed chemistry expertise. The inventive approach described herein arises in part from an understanding of how to use chemical components to achieve effective metal and alloy products using binder jetting.

From further aspects the present disclosure provide functional binder compositions used in various methods of the present disclosure.

The inks infiltrate the porosity (typically about 40% porosity) in the powder bed lay up. The infiltrated material may optionally comprise up to 20% by volume of reactive binder (e.g. ROM) with the balance being comprised of particles, other components and carrier. Together these components act as an infiltrating metallic binder to hold the 3D part in a green state until it can be subsequently consolidated by heat treatment. By filling the powder lay-up with metal binder the final porosity, distortion and shrinkage of the finished part are reduced. The reactive organometallic (ROM) compounds used as the basis for ink formulations of exemplary embodiments of the present disclosure may be volatile metal precursors developed for chemical vapor deposition processes. For example, a suitable titanium ROM may be represented by the general formula Til_4 where L represents a volatile ligand. The titanium ROM may be a volatile titanium amide, e.g. of the general formula Ti(NRiR2)4 where R represents an alkyl group.

In such cases it may be postulated that a reaction taking place between the titanium hydride in the powder bed and the titanium organometallic material (Til_4 where L represents a ligand) in the functional binder is as follows:

The inks may incorporate certain concentrations of the ROM component (e.g. about 5-50%, e.g. 10-40%, e.g. 20-30%, w/w) combined with certain loadings of metal micro- and nano-particles (e.g. about 10-60%, e.g. 20-50%, e.g. 30-40%, w/w). The melting temperature of very small nanoparticles is typically suppressed compared with the bulk, because the relief of the very high surface energy: volume ratio provides the thermodynamic driving force for melting or sintering. Optionally further components may be present, for example to control the reactivity of metal nanoparticles towards unwanted reactions (e.g. oxidation) before they can be incorporated into the 3D metal part. The use of pre-treatments can “cap” or encapsulate the nanoparticles in a protective layer to stop oxidation. Optionally ionic surfactants (e.g. Brij™ or Tween™ ) may be used to deliver metallic fillers into the porosity left by the feedstock powder. For larger micron-scale filler metal particles encapsulation is generally not necessary; however optionally the surface passivation layers on these particles may be reduced via a range of reducing pre treatments. Optionally encapsulation may be used to reduce the extent of unwanted native oxide into the RMJF 3D parts. Optionally viscosity modifiers and surfactants may be used to inhibit particle agglomeration in order to suspend the metal particulates in the ROM solutions.

From further aspects the present disclosure provide 3D printed products obtained or obtainable by exemplary methods of the present disclosure. These are distinguishable from products made by other methods because of their properties, for example their porosity, reduced oxygen content and lack of contaminants or sacrificial binder residue.

Thus from a further aspect the present disclosure provides a 3D printed product comprising fused particles of a metal or metals formed from a metal compound or meta compounds infiltrated with binder-jetted fused metal or metals. The oxygen content of said product may optionally be less than 1 wt. %, or less than 0.5 wt. %, or less than 0.1 wt. %, or less than 0.05 wt. %, or less than 0.01 wt. %, or less than 0.005 wt. %, or less than 0.001 wt. %.

For example, said 3D printed product may comprise fused particles of titanium formed from titanium hydride infiltrated with binder-jetted fused titanium.

Various embodiments of the present disclosure allow the preparation of products which have properties suitable for their function.

Because the binder used in exemplary embodiments of the present disclosure is not a sacrificial binder and becomes part of the build material, the resultant product can exhibit improved properties structurally (e.g. strength or fatigue resistance), in terms of conductivity (electrically or thermally), or in other ways. Without wishing to be bound by theory, exemplary embodiments of the present disclosure ameliorate the flaws in the product due to cracks and porosity thereby improving the mechanical properties. For example, it may be that a product made in accordance with exemplary embodiments of the present disclosure has an ultimate tensile strength of greater than 30 MPa, greater than 50 MPa, greater than 100 MPa, greater than 200 MPa, greater than 500 MPa, greater than 1,000 MPa or greater than 10,000 MPa. This may be parallel to the layers formed in the process, or perpendicular, or both.

It may be that a product, component, or part made in accordance with exemplary embodiments of the present disclosure is an aerospace component, an engineering component, a marine plant component, a component used in a military or weaponry application, a structural component, a medical device component, an implant or component thereof, a prosthesis or component thereof, or an automotive component.

It may be that the product has a porosity of less than 10%, or less than 5%, or less than 1% of the bulk volume.

The inkjet binder printer used may be based on any suitable print head technology. Examples of suitable print heads include Xaar print heads (e.g. Xaar 1003 heads), or TTPs “Vista” technology print heads.

The binder jet printer is capable of printing metallic functional binders for multiple materials and layering metal powder feed stocks.

Optionally the binder printing system incorporates print heads that are capable of jetting micron-sized particles. This binder printing system enables flexibility in the use of a range of binder inks and produces a print system that is capable of building complex 3D components beyond what is currently feasible using known procedures.

From a further aspect the present disclosure provides an apparatus for carrying out the method in exemplary embodiments of the present disclosure.

The skilled person will understand that the different components of the binder may play different roles.

The nanoparticulate material may allow the sintering temperature to be reduced and plays a role in reducing porosity. It becomes part of the build material (i.e. is non-sacrificial). The microparticulate material also plays a role in reducing porosity, at a different level. It becomes part of the build material (i.e. is non-sacrificial). The ROM or other molecular material may help carry the particulate material to facilitate jetting, may bind the powder bed together, and converts to a material (e.g. metal) which becomes part of the build material (i.e. is non-sacrificial).

Thus the conformal coating and reaction facilitated by the ROM or other molecular material, in combination with the further space-filling provided by the other components, and the sintering to produce a fully-filled, fully-functional, material, can bring about considerable advantages compared to known methods. Waste and burn-off of materials are avoided, and the product has improved properties.

Alloys and other composite materials may be made by for example using a component (e.g. the microparticulate component or alternatively/additionally one of the other components) which is different to the powder bed material. Some exemplary embodiments of the present disclosure will now be described in further non-limiting detail with reference to the drawings.

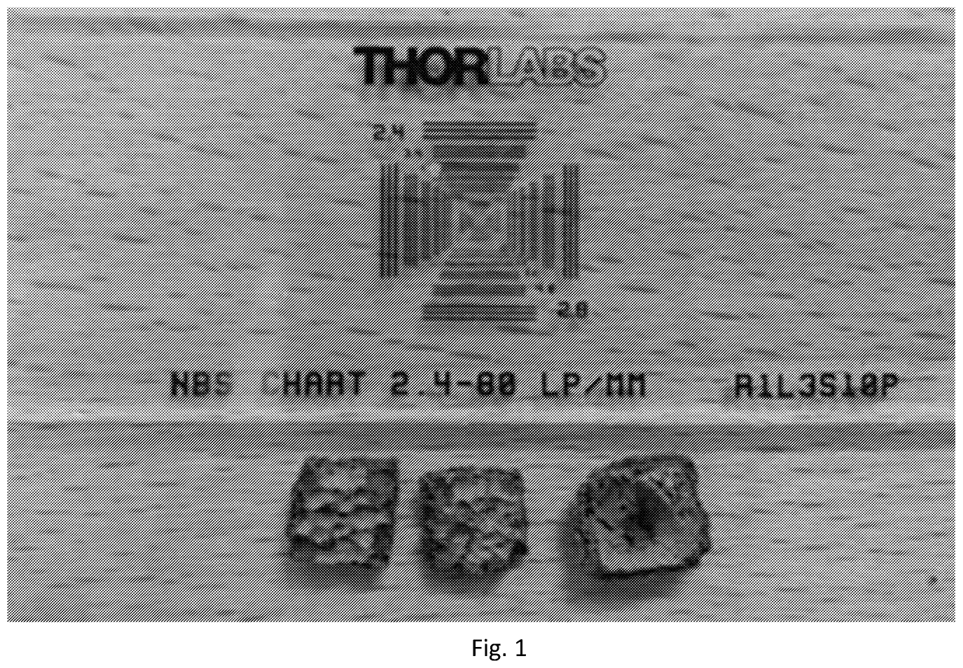

FIG. 1 1 shows products formed on reaction of titanium hydride powders with a binder comprising tetrakis(dimethylamido)titanium;

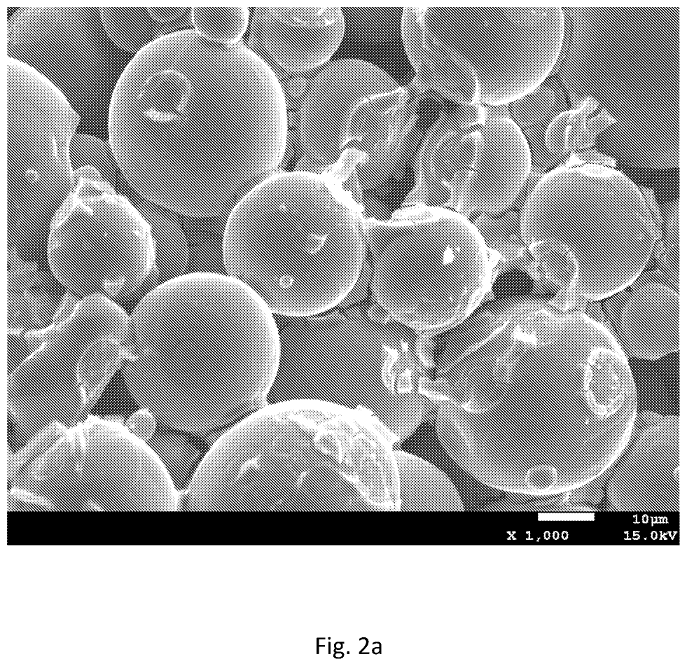

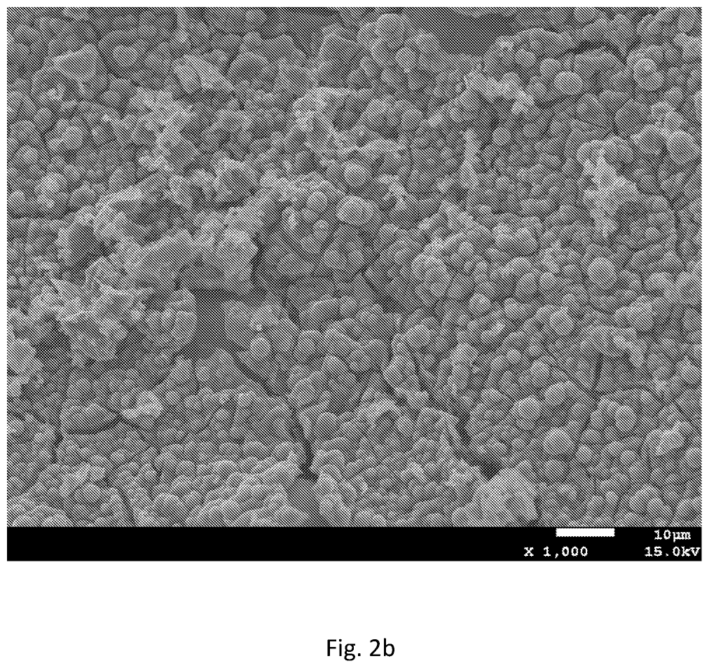

FIG. 2a shows an SEM image of a comparative example, being a reaction product of elemental titanium powder (in the absence of titanium hydride) with tetrakis(dimethylamido)titanium; FIG. 2b shows an SEM image of a reaction product of a powder mixture of elemental titanium and titanium hydride with tetrakis(dimethylamido)titanium; and

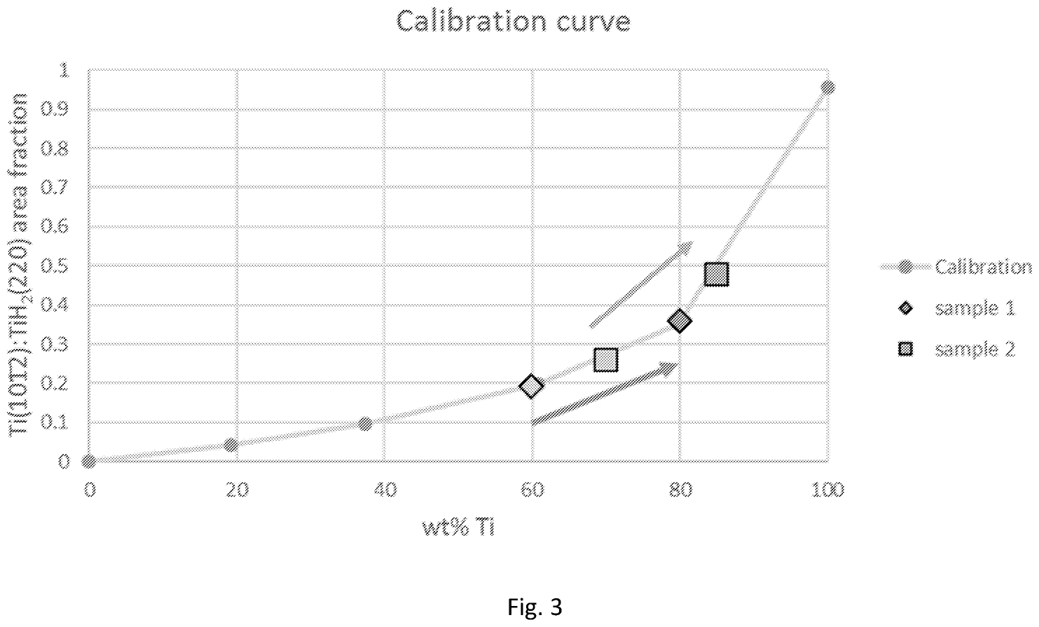

FIG. 3 shows increases in titanium content brought about when producing build material from two different powder blends of CP-TkTiFb. In order to produce parts, it is necessary to deposit, layer by layer, the powder bed and to deliver ink formulations onto that bed in a controlled manner. In some embodiments the print-heads used are Xaar (e.g. Xaar 1003) heads or TTPs Vista heads which use a mechanical ejection process cable of delivering large sedimenting particle loaded inks.

The powder bed may include a heating system that can heat the bed, with the maximum bed temperature likely to be 100° C., for example up to 50° C. In some cases heat does not need to be applied. Elevated bed temperature, where required, may be achieved by the use of a heater system under the bed or by radiant heaters above the bed, the objective being to activate the reactive binder (e.g., in the case of ROMs, to drive off the ligands from the ROM active part of the ink) and optionally to sinter the nanoparticles in the nano-component of the ink. This produces a fully-dense-high-strength “green” part, which can then be heat treated to create the correct final microstructure for functional use. Thus the moderate temperature at this stage fuses the nanoparticles and enables the reactive binder to release elemental metallic coating, whereas the post-processing heating fuses the larger microparticles.

Optionally the method lays metal powders with 25 pm precision, using a hopper-feed and wiper blade mechanism, which are designed to operate up to the maximum powder bed temperature. The print head and powder bed may be housed in a controlled environmental chamber (N2 or Ar) to minimize atmospheric contamination and vent unwanted, noxious by-products. The system may be automated and run under computer control with a suitable build volume (e.g. 250×250×250 mm).

Ti/TiH2 powder+Tetrakis(dimethylamido)Titanium (TDMA-Ti)/toluene test results

TDMA-Ti drop tests on to TiH? powder

TDMA-Ti was pipetted onto Tihh powders at 100° C. in an N2 atmosphere. Powder particles were fused after reaction with TDMA-Ti giving porous “green parts” (FIG. 1). It is believed that the reaction taking place, when under inert atmosphere, is as follows:

2TiH2+Ti(NMe2)4 3Ti+4HNMe2

Drop tests of TDMA-Ti onto commercially pure (CP)-Ti and mixed CP-Ti/TiH2

By way of comparison, drop tests of TDMA-Ti at 100° C. on commercially pure (CP) Ti in an inert atmosphere resulted in very loosely bound material (FIG. 2a). Drop tests of TDMA-Ti onto mixed CP-Ti and TiH2 resulted in a stronger part with near continuous solid film at upper surface (FIG. 2b).

### Further Tests

Under an Ar atmosphere at RT (˜15° C.), an X-ray diffraction (XRD) powder sample holder was filled with a 60:40 powder blend of CP-Ti:TiH2. 60 wt % TDMA-Ti in toluene was pipetted onto the powder until saturated. A second XRD sample holder was filled with 70:30 blend of CP-Ti:TiH2 and 60% TDMA-Ti in toluene was pipetted in until saturated. Samples were left to dry under Ar for ˜1 hour. XRD between 2theta values of 50° and 62° was then used to assess the relative area ratios of the Ti (1012) and TiH2 1220) peaks and compared against the ratios for known mixtures of Ti/TiH2 (FIG. 3).

FIG. 3 shows an XRD calibration curve (circles and line) for mixtures of Ti/TiH2. Diamond and square markers indicate Ti composition as mixed (lower content) and after TDMA-Ti drop tests (higher content).

XRD results show that titanium hydride is converted to titanium during the process. They indicate that the Ti fraction increased by around 20% for the 60 wt % Ti mixture and by around 15% for the 70 wt % Ti mixture. The difference in the increase may be attributed to the availability of TiH2 within the mixtures, a higher proportion of which would enable the reaction quoted above to proceed further.

### Aluminum Products and Aluminum Alloy Products

Various embodiments of the present disclosure in relation to titanium also apply, mutatis mutandis, to other metals, for example aluminum. One suitable category of products which may be prepared in accordance with exemplary embodiments of the present disclosure may include aluminum products and aluminum alloy products. The control allowed by the present invention means that it is particularly effective and advantageous in the preparation of aluminum-containing products.

For example, the compound of a first metal, or at least one of them, may be a metal hydride. To produce pure aluminum products, the compound of a first metal used in the powder bed is an aluminum compound, for example aluminum hydride, and the functional binder in the ink is an aluminum-containing binder. To produce aluminum alloy products, one possibility is that the compound in the powder bed may be an aluminum compound, for example aluminum hydride, and the other metal(s) in the alloy may be derived from other (elemental) metal particles in the powder bed or derived from material in the binder, as well as further aluminum being optionally present in the powder bed and/or binder. An alternative possibility for aluminum alloy products is that the compound in the powder bed may be a compound of a metal which alloys with aluminum, for example a hydride of said metal (other than aluminum), and the aluminum in the alloy may be derived from aluminum metal particles in the powder bed and/or derived from material in the binder.

Thus, to make pure aluminum products, it is necessary to use an aluminum-containing functional binder, and a powder bed containing an aluminum compound, for example aluminum hydride. Optionally, elemental aluminum may also be present in the powder bed. Optionally elemental aluminum may also be present in the binder.

To make aluminum alloy products, it is necessary to incorporate one or more other metal which alloys with aluminum, and this can be done by including said other metal(s) in the powder bed or in the binder or both. Said other metal may be in elemental form in the powder bed and/or binder, and/or may be in the reactive compound of the powder bed and/or the functional binder. To prepare such aluminum alloys, aluminum may be in elemental form in the powder bed and/or binder, and/or may be in the reactive compound of the powder bed and/or the functional binder. One exemplary method within the scope of the present disclosure uses aluminum hydride as an essential component in the powder bed. This is a method of 3D printing an aluminum or aluminum alloy product comprising: a) providing a layer of a powder bed which comprises aluminum hydride particles (e.g. powder or powders) and optionally particles of elemental aluminum and/or optionally other elemental metal(s) which are suitable for alloying with aluminum; b) jetting a functional binder onto selected parts of said layer, wherein said functional binder infiltrates into pores in the powder bed, reacts with aluminum hydride particles to form elemental aluminum, and locally fuses elemental metal particles of the powder bed in situ, c) sequentially repeating said steps of applying a layer of powder on top and selectively jetting functional binder, multiple times, to provide a powder bed bonded at selected locations by printed functional binder; and d) taking the resultant bound 3D structure out of the powder bed.

For example: a suitable method of making a pure aluminum product in accordance with exemplary embodiments of the present disclosure is to use an aluminum-containing binder in combination with a powder bed which consists of aluminum hydride; another suitable method of making a pure aluminum product in accordance with exemplary embodiments of the present disclosure is to use an aluminum-containing binder in combination with a powder bed which consists of aluminum hydride and elemental aluminum; a suitable method of making an aluminum alloy product in accordance with exemplary embodiments of the present disclosure is to use an aluminum-containing binder in combination with a powder bed which consists of aluminum hydride and elemental other metal(s); another suitable method of making an aluminum alloy product in accordance with exemplary embodiments of the present disclosure is to use an aluminum-containing binder in combination with a powder bed which consists of aluminum hydride, optionally elemental aluminum and elemental other metal(s); another suitable method of making an aluminum alloy product in accordance with exemplary embodiments of the present disclosure is to use a binder which contains a metal which alloys with aluminum (regardless of whether said binder also contains aluminum) in combination with a powder bed which consists of aluminum hydride, optionally elemental aluminum and optionally elemental other metal(s).

Thus, when making an alloy, one option is to include the alloying material in the powder bed; another option is to include the alloying material in the ink; a further option is to have alloying material in both the ink and the powder bed.

The other metal(s) include one or more of those which are known to alloy with aluminum, such as copper, magnesium, chromium, zinc, zirconium, manganese, titanium, iron, cobalt, nickel, and/or silicon.

One group of suitable resultant alloys is that wherein the alloys contain aluminum and copper. One example within this group is aluminum alloy 2024. The skilled person will be aware that this is an alloy which contains approximately 3.8-4.9 wt % copper and optionally up to approximately 0.5 wt % silicon, optionally up to approximately 0.5 wt % iron, optionally approximately 0.3 to 0.9 wt % manganese, optionally approximately 1.2 to 1.8 wt % magnesium, optionally up to approximately 0.1 wt % chromium, optionally up to approximately 0.25 wt % zinc, optionally up to approximately 0.15 wt % titanium, and optionally up to approximately 0.05 wt % other elements to a maximum of 0.15% such other elements, the balance being aluminum (e.g. 90.7-94.7 wt %) and unavoidable impurities.

Another group of suitable resultant alloys is that wherein the alloys contain aluminum and magnesium and optionally chromium. One example within this group is aluminum alloy 5052. The skilled person will be aware that this is an alloy which contains approximately 2.2-2.8 wt % magnesium, approximately 0.15-0.35 wt % chromium, and optionally up to approximately 0.25 wt % silicon, optionally up to approximately 0.4 wt % iron, optionally up to approximately 0.1 wt % manganese, optionally up to approximately 0.1 wt % zinc, the balance being aluminum and unavoidable impurities. Another group of suitable resultant alloys is that wherein the alloys contain aluminum and zinc, and optionally magnesium, copper and zirconium. One example within this group is aluminum alloy 7068. The skilled person will be aware that this is an alloy which contains approximately 7.3-8.3 wt % zinc, approximately 2.2-3.0 wt % magnesium, approximately 1.6-2.4 wt % copper, approximately 0.05-0.15 wt % zirconium, and optionally up to approximately 0.25 wt % silicon, optionally up to approximately 0.4 wt % iron, optionally up to approximately 0.12 wt % silicon, optionally up to approximately 0.15 wt % iron, optionally up to approximately 0.1 wt % manganese, optionally up to approximately 0.05 wt % chromium, optionally up to approximately 0.1 wt % titanium, the balance being aluminum and unavoidable impurities.

Another group of suitable resultant alloys is that wherein the alloys contain aluminum, magnesium and silicon. One example within this group is aluminum alloy 6061. The skilled person will be aware that this is an alloy which contains approximately 0.8-1.2 wt % magnesium, approximately 0.4-0.8 wt % silicon, and optionally up to approximately 0.7 wt % iron, optionally approximately 0.15-0.4 wt % copper, optionally approximately 0.04-0.35 wt % chromium, optionally up to approximately 0.25 wt % zinc, optionally up to approximately 0.25 wt % titanium, optionally up to approximately 0.15 wt % manganese, the balance being aluminum and unavoidable impurities.

In such scenarios, exemplary embodiments of the present disclosure can differ from known methods by having, as an essential, reactive, component, aluminum hydride in the powder bed. This reacts to form aluminum during the process. The presence of this reactive component (aluminum hydride) in the powder bed, in the context of exemplary methods of the present disclosure, can bring particular advantageous effects.

An advantage of using aluminum hydride in the powder bed is that this better controls reactivity during the formation of the aluminum build material, compared to powder beds which contain elemental aluminum. When elemental aluminum alone is used in the powder bed, undesirable oxidation can occur more readily, and/or other side reactions may occur more readily. This can lead to an inferior product or lower purity. Without wishing to be bound by theory, this undesirable effect is thought to be due to reaction of the elemental aluminum powder bed particles when the functional binder is used to bind the powder bed particles together. The presence of aluminum hydride reduces the amount of oxidation or other undesirable reaction taking place.

A further advantage of using a compound of a first metal, for example aluminum hydride, in the powder bed is that this allows the packing density to be controlled and enhanced. Conventionally, binder jetting takes place onto powder beds which contain approximately spherical particles of elemental material, and a maximum bed density of around 60% is achieved. The compound of the first metal, for example aluminum hydride, can be in the form of particles which can have a range of shapes and dimensions including irregular and dendritic forms which can pack well. Thus a beneficial density modification effect is observed.

This beneficial density modification effect is particularly pronounced when the powder bed contains not only the compound of the first metal, for example aluminum hydride, but also particles of other material. The presence of two or more types of material, typically aluminum hydride particles and elemental aluminum particles and/or particles of other metal, in the powder bed, facilitates a bimodal or multimodal size distribution which leads to improved part density.

An organometallic material used in the functional binder may be an aluminum precursor, i.e. an aluminum compound which reacts to form elemental aluminum. Suitable organoaluminium compounds include aluminum (III) compounds. These include compounds with the empirical formula AlR3, in which R may denote one or more than one alkyl (e.g. methyl and/or ethyl) or aryl moiety, i.e. aluminum trialkyls or aluminum triaryls. They may exist as dimers, i.e. Al2R6. One or more of the R groups may be replaced by H, i.e. suitable compounds include not only alkylaluminiums but also alkylaluminium hydrides. Suitable materials also include adducts, e.g. adducts with amines. Examples of suitable organometallic materials include trimethylaluminum, dimethylaluminum hydride, and dimethylethylamine alane.

While the present disclosure has been particularly shown and described with reference to specific embodiments, it should be understood by those skilled in the art that various changes in form and detail may be made therein without departing from the spirit and scope of the invention as defined by the appended claims. Further, while the present disclosure is presented in terms of exemplary embodiments, it should be appreciated that individual aspects of the disclosure can be separately claimed. The scope of the invention is thus indicated by the appended claims, and all changes within the meaning and range of equivalency of the claims are therefore intended to be embraced.

What is claimed is:

1. A method of 3D printing a metal or alloy product comprising:
providing a layer of a powder bed which comprises a compound of a first metal;
jetting a functional binder onto selected parts of said layer, wherein said functional binder infiltrates into pores in the powder bed, reacts with said compound of a first metal to form said first metal in elemental form, and locally fuses elemental metal particles of the powder bed in situ;
sequentially repeating said steps of applying a layer of powder on top and selectively jetting functional binder, multiple times, to provide a powder bed bonded at selected locations by printed functional binder; and
taking the resultant bound 3D structure out of the powder bed.

2. The method as claimed in claim 1 wherein said compound of a first metal is a metal hydride, metal carbide, metal boride or metal nitride.

3. The method as claimed in claim 1 wherein said compound of a first metal is one or more of a titanium compound, aluminum compound, vanadium compound, niobium compound, tantalum compound, zirconium compound, iron compound, chromium compound, cobalt compound, nickel compound or copper compound.

4. The method as claimed in claim 3 wherein said compound of a first metal is titanium hydride, aluminum hydride, vanadium hydride or niobium hydride.

5. The method as claimed in claim 1, wherein the powder bed comprises more than one metal compound.

6. (canceled)

7. The method as claimed in claim 1, further comprising a subsequent step of heat treatment either inter-layer or post-build to further fuse the 3D structure.

8. The method as claimed in claim 1, wherein the functional binder comprises a metallic compound which is a precursor of elemental metal.

9. The method as claimed in claim 8, wherein the functional binder comprises a titanium precursor.

10. The method as claimed in claim 9, wherein the titanium precursor is an organometallic material.

11. The method as claimed in claim 10, wherein the organometallic material is a titanium (IV) compound with at least one ligand which is an amine ligand.

12. The method as claimed in claim 11 wherein the organometallic material is tetrakis(dimethylamino)titanium(IV).

13. The method as claimed in claim 1, which is a method of 3D printing a titanium product and wherein the powder bed comprises titanium hydride particles and particles of elemental titanium.

14. The method as claimed in claim 1 which is a method of 3D printing a titanium alloy product and wherein the powder bed comprises titanium hydride particles, particles of elemental titanium and particles of elemental one or more other metals which alloy with titanium.

15. The method as claimed in claim 14 wherein said one or more other metals are selected from one or more of aluminum, vanadium and niobium.

16. (canceled)

17. The method as claimed in claim 1 further comprising a subsequent step of heat treatment either inter-layer or post-build to further fuse the 3D structure.

18. The method as claimed in claim 1, wherein the functional binder comprises a metallic compound which is a precursor of elemental metal.

19. The method as claimed in claim 18 wherein the functional binder comprises an aluminum precursor.

20. The method as claimed in claim 19, wherein the aluminum precursor is an organometallic material.

21. The method as claimed in claim 20, wherein the organometallic material is an aluminum (III) compound wherein aluminum centers are bonded to alkyl, hydrogen and/or amine groups.

22. The method as claimed in claim 21, wherein the organometallic material is selected from the group consisting of trimethylaluminum, dimethylaluminum hydride, and dimethylethylamine alane.

23. The method as claimed in claim 1, which is a method of 3D printing an aluminum product and wherein the powder bed comprises aluminum hydride powder and particles of elemental aluminium.

24. The method as claimed in claim 1, which is a method of 3D printing an aluminum alloy product and wherein the powder bed comprises aluminum hydride powder, particles of elemental aluminum and particles of elemental one or more other metals which alloy with aluminum.

25. The method as claimed in claim 24 wherein said one or more other metals are selected from one or more of copper, magnesium, chromium, zirconium, or silicon.

26. The method as claimed in claim 1, wherein the binder further comprises metallic nanoparticles with sizes within a range of 1 to 100 nm.

27. The method as claimed in claim 1, wherein the binder further comprises metallic microparticles with sizes within a range of 0.1 to 10 microns.

28. The method as claimed in claim 1, wherein the functional binder is jetted onto the powder bed without applying heat or at a temperature of up to 100° C.

29. (canceled)

30. (canceled)

31. A 3D printed product comprising fused particles of titanium formed from titanium hydride infiltrated with binder-jetted fused titanium.

32. A 3D printed product comprising fused particles of aluminium formed from aluminium hydride infiltrated with binder-jetted fused aluminium.

33. (canceled)

34. (canceled)

35. The method as claimed in claim 1, wherein said first metal is in elemental form.
